(19) United States
(12) Patent Application Publication
(10) Pub. No.: US 2023/0022240 A1
(43) Pub. Date: Jan. 26, 2023

(54) FRONT BODY VEHICLE ASSEMBLY

(71) Applicant: Electric Last Mile, Inc., Debtor, Wilmington, DE (US)

(72) Inventor: SAMUEL ZENG, Rochester Hills, MI (US)

(73) Assignee: Electric Last Mile, Inc., Debtor, c/o David W. Carickhoff, Chapter 7 Trustee, Wilmington, DE (US)

(21) Appl. No.: 17/849,044

(22) Filed: Jun. 24, 2022

Related U.S. Application Data
(60) Provisional application No. 63/216,208, filed on Jun. 29, 2021.

(51) Int. Cl. B62D 21/15; B60K 1/04; B60R 19/34; B60R 19/18

(52) U.S. Cl. CPC B62D 21/152; B60K 1/04; B60R 19/34; B60R 19/18; B60K 2001/0411

(57) ABSTRACT

An energy-absorbing impact assembly for an electric vehicle includes a bumper assembly. The bumper assembly includes an elongated center beam that extends laterally from a first end to a second end and longitudinally between a front side and a rear side. The energy-absorbing impact assembly includes a tubular support positioned on the rear side of the elongated center beam. The energy-absorbing impact assembly includes a crash box positioned on the rear side of the elongated center beam. The energy-absorbing impact assembly includes a ring assembly positioned on the rear side of the elongated center beam. The ring assembly includes a ring body and a plurality of struts that extend from the ring body. The bumper assembly, the tubular support, the crash box, or the ring assembly are configured to deform upon impact.

### CROSS REFERENCE TO RELATED APPLICATION

This application claims the benefit of U.S. Provisional Applications No. 63/216,208 filed on Jun. 29, 2021.

### BACKGROUND

The present disclosure relates generally to a front body vehicle assembly including a bumper assembly. More specifically, the present disclosure relates to a front body vehicle assembly for an electric vehicle configured to protect an electric battery of the vehicle from being damaged.

### SUMMARY

One embodiment relates to an energy-absorbing impact assembly for an electric vehicle. The energy-absorbing impact assembly can include a bumper assembly. The bumper assembly can include an elongated center beam that extends laterally from a first end to a second end and longitudinally between a front side and a rear side. The energy-absorbing impact assembly can include a tubular support positioned on the rear side of the elongated center beam for supporting the bumper assembly. The energy-absorbing impact assembly can include a crash box positioned on the rear side of the elongated center beam for supporting the bumper assembly. The energy-absorbing impact assembly can include a ring assembly positioned on the rear side of the elongated center beam. The ring assembly can include a ring body and a plurality of struts that extend from the ring body. The bumper assembly, the tubular support, the crash box, or the ring assembly are configured to deform with impact.

One embodiment relates to an electric vehicle. The electric vehicle can include a front end and a front wheel. The electric vehicle can include an electric battery assembly. The electric battery assembly can include an electric battery. The electric vehicle can include an energy-absorbing impact assembly positioned at the front end of the electric vehicle. The energy-absorbing impact assembly can include a bumper assembly. The bumper assembly can include an elongated center beam that extends laterally from a first end to a second end and longitudinally between a front side and a rear side. The energy-absorbing impact assembly can include a crash box positioned on the rear side of the elongated center beam for supporting the bumper assembly. The energy-absorbing impact assembly can include a ring assembly positioned on the rear side of the elongated center beam. The ring assembly can include a ring body and a plurality of struts that extend from the ring body. The bumper assembly, the crash box, or the ring assembly are configured to deform with impact.

One embodiment relates to a method of absorbing energy of an impact of an electric vehicle. The method can include deforming a hollow, elongated beam of a bumper assembly. The method can include deforming a crash box. The method can include deforming an elongated tubular support. The method can include deforming a ring body of a ring assembly. The bumper assembly can include a front side, positioned towards a front end of the electric vehicle, and a rear side. The elongated tubular support can be positioned on the rear side of the bumper assembly. The ring assembly can be positioned on the rear side of the bumper assembly.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective side view of an electric vehicle, according to an exemplary embodiment.

FIG. 2 is a bottom view of the electric vehicle of FIG. 1, according to an exemplary embodiment.

FIG. 3 is an exploded perspective view of a portion of an energy-absorbing impact assembly of the electric vehicle of FIG. 1, according to an exemplary embodiment.

FIG. 4 is a perspective view of the energy-absorbing impact assembly of FIG. 3, according to an exemplary embodiment.

FIG. 5 is a perspective view of a portion of the energy-absorbing impact assembly of the electric vehicle of FIG. 1, according to an exemplary embodiment.

FIG. 6 is a perspective view of a portion of an energy-absorbing impact assembly of the electric vehicle of FIG. 1, according to an exemplary embodiment.

FIG. 7 is a perspective view of a portion of an energy-absorbing impact assembly of the electric vehicle of FIG. 1 in a normal state, according to an exemplary embodiment.

FIG. 8 is a perspective view of a portion of an energy-absorbing impact assembly of the electric vehicle of FIG. 1 in a deformed state, according to an exemplary embodiment.

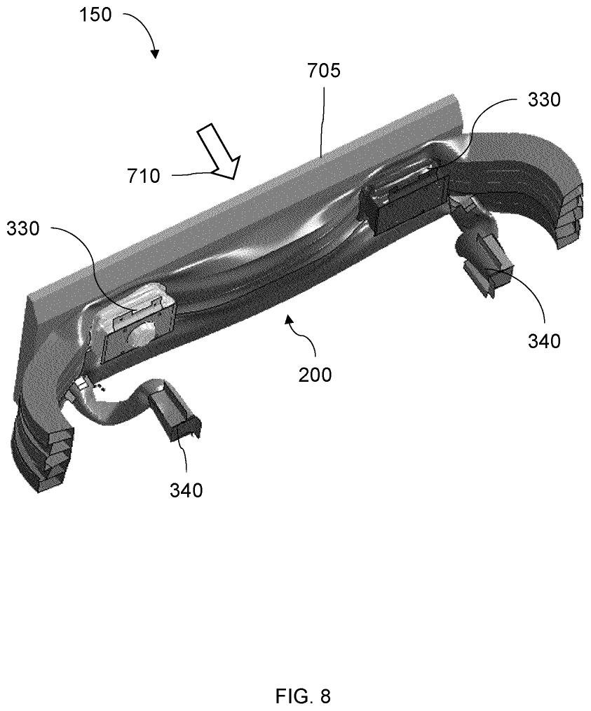

FIG. 9 is an exploded perspective view of a portion of an energy-absorbing impact assembly of the electric vehicle of FIG. 1, according to an exemplary embodiment.

FIG. 10 is a graphic visual of a load force of a crash box of an energy-absorbing impact assembly of the electric vehicle of FIG. 1 relative to a displacement, according to an exemplary embodiment.

FIG. 11 is a graphic visual of a load force of a tubular support of an energy-absorbing impact assembly of the electric vehicle of FIG. 1 relative to a displacement, according to an exemplary embodiment.

FIG. 12 is a graphic visual of a total energy value of various components of an energy-absorbing impact assembly of the electric vehicle of FIG. 1 relative to a displacement, according to an exemplary embodiment.

FIG. 13 is an illustration of a process of absorbing energy of an impact of an electric vehicle, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, an electric vehicle or hybrid-electric vehicle can include an electric battery and an energy-absorbing impact assembly. Non-electric vehicles can generally include several components, such as a bumper and engine hood, for absorbing the energy of an impact, such as a crash or collision with an object. In some electric vehicles, however, the position of an electric battery can vary in comparison to an engine of a non-electric vehicle. To facilitate preventing damage to the electric battery, a front body energy-absorbing impact assembly can include a bumper assembly and various other components that deform to absorb energy of impact.

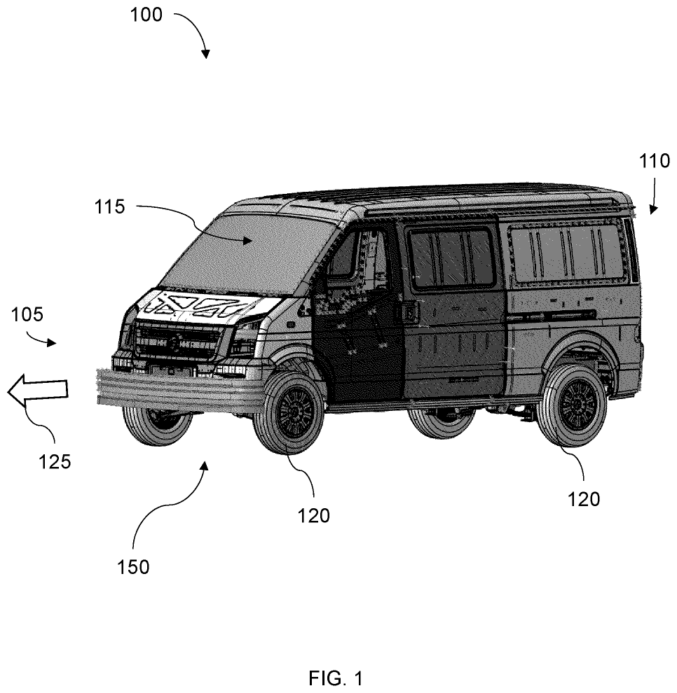

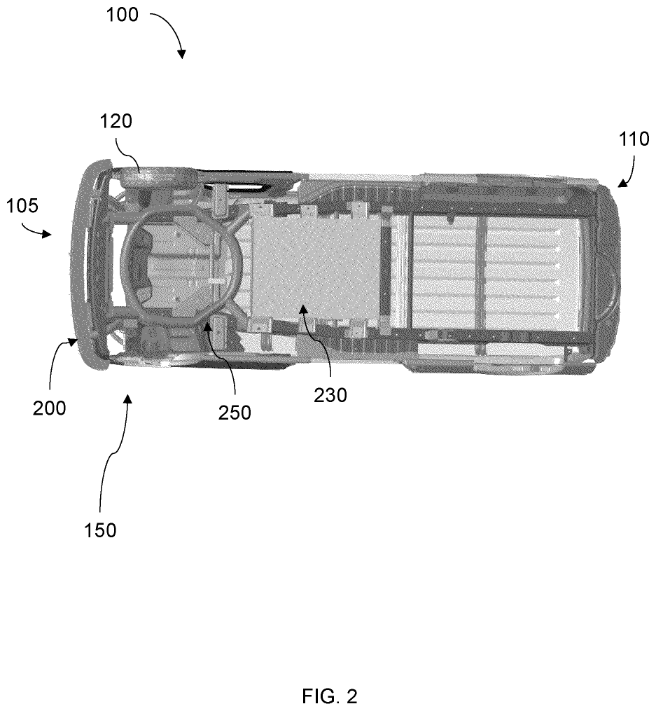

As shown in FIGS. 1 and 2, an electric vehicle 100 can include a front end 105 and a rear end 110 such that, in a normal operating position, the front end 105 is at the front of a forward direction of travel, as shown in arrow 125. The electric vehicle 100 can include an operating cabin 115, shown as cabin 115. Generally, the operating cabin 115 can be enclosed by a body of the electric vehicle 100. For example, the body of the electric vehicle 100 can include a frame and a plurality of wheels 120 coupled to the frame for movably supporting the electric vehicle 100 relative to a plane (e.g., road, ground, etc.). By way of example, the operating cabin 115 can include one or more seats for a user to operate the electric vehicle 100. According to another example, the electric vehicle 100 may be operated autonomously or semi-autonomously (e.g., vehicle includes a sensor for automatic steering, etc.). The electric vehicle 100 can include two front wheels 120 and two rear wheels 120, as shown in FIG. 1. The electric vehicle 100 can include an electric battery assembly 230, shown as assembly 230. For example, the electric battery assembly 230 can include an electric battery and several components to couple the electric battery with the electric vehicle 100. Generally, the electric vehicle 100 can operate by receiving a charge to the electric battery through one or more means including, but not limited to, an aerial vehicle charging system, an emergency charging system, and a highway charging system. In one embodiment, the electric battery assembly 230 can be positioned on an underside of the electric vehicle, as shown in FIG. 2. In one embodiment, the electric vehicle 100 is configured as an on-road vehicle such as a sedan, a sport utility vehicle (“SUV”), a pickup truck, a van, and/or still another type of passenger vehicle. In other embodiments, the electric vehicle 100 is configured as another type of on-road vehicle such as a semi-truck, a bus, or the like. In still other embodiments, the electric vehicle 100 is configured as an off-road vehicle such as construction machinery, farming machinery, or the like.

As shown in FIGS. 1 and 2, and among others, the electric vehicle 100 can include an energy-absorbing impact assembly 150 coupled with the electric vehicle 100. By way of example, the energy-absorbing impact assembly 150 can be positioned at the front end 105 of the electric vehicle 100 to absorb energy (e.g., generated force, potential, reaction, etc.) of a front-end collision. The energy-absorbing impact assembly 150 can be configured to absorb energy to facilitate protection of the electric battery assembly 230, according to an exemplary embodiment. As described in more detail herein, the energy-absorbing impact assembly 150 can include various components that are configured to deform (e.g., buckle, collapse, fold, crumple, misshape, disfigure, etc.) to absorb energy during impact (e.g., crash, collision, etc.). By way of example, the energy-absorbing impact assembly 150 of the electric vehicle 100 can be configured to collapse, buckle, or otherwise deform during impact (e.g., a collision with another vehicle or object) such that the energy of the impact does not severely damage the electric battery assembly 230.

As shown in FIGS. 2-4, and among others, the energy-absorbing impact assembly 150 can include a bumper assembly 200. The bumper assembly 200 can be positioned at the front end 105 of the electric vehicle 100 such that the bumper assembly 200 is the front-most portion of the energy-absorbing impact assembly 150 when the electric vehicle 100 is operating under normal operating conditions and is therefore configured to be a first point of contact upon impact. The bumper assembly 200 can include an elongated center beam 300 that extends laterally from a first end 305 to a second end 310. For example, the elongated center beam 300 can include at least one portion that extends along an axis generally perpendicular to a forward direction of travel of the electric vehicle 100, as shown by arrow 125. The elongated center beam 300 can extend longitudinally between a front side 315 and a rear side 320. For example, the elongated center beam 300 can include at least on portion that extends along an axis generally parallel with a forward direction of travel of the electric vehicle 100, as shown by arrow 125.

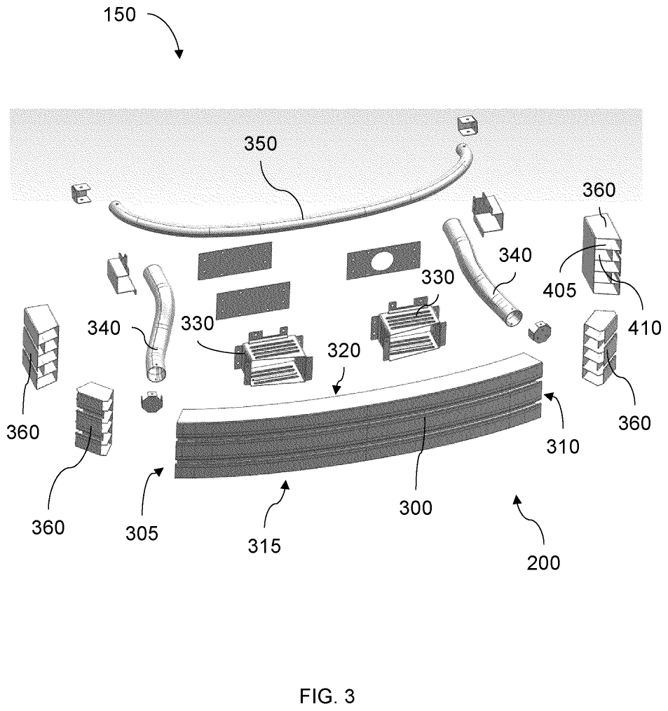

The bumper assembly 200 can include one or more additional support beams 360. In one embodiment, the bumper assembly 200 can include two support beams 360, shown as support beams 360. For example, a first support beam 360 can abut against the first end 305 of the elongated center beam 300. A second support beam 360 can abut against the second end 310 of the elongated center beam 300. According to other exemplary embodiments, the bumper assembly 200 can include more than two support beams 360, as shown in FIG. 3. While the support beams 360 shown in the embodiment of FIG. 3 are separate from the elongated center beam 300, the support beams 360 can be directly attached (e.g., welded, joint, molded, fastened, etc.) to the elongated center beam 300 according to other exemplary embodiments.

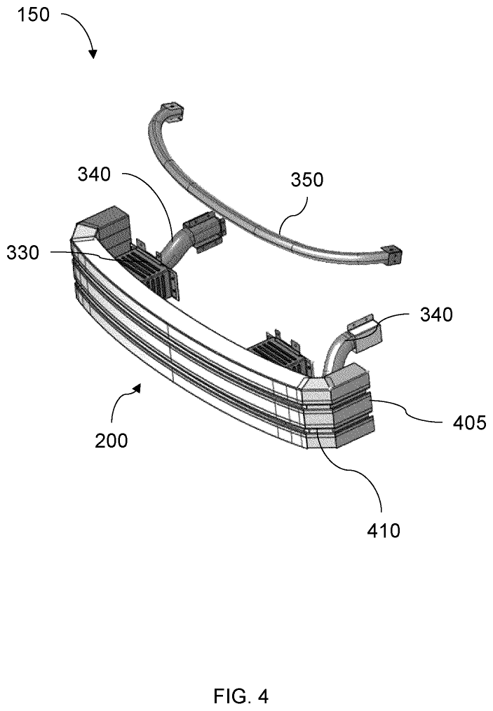

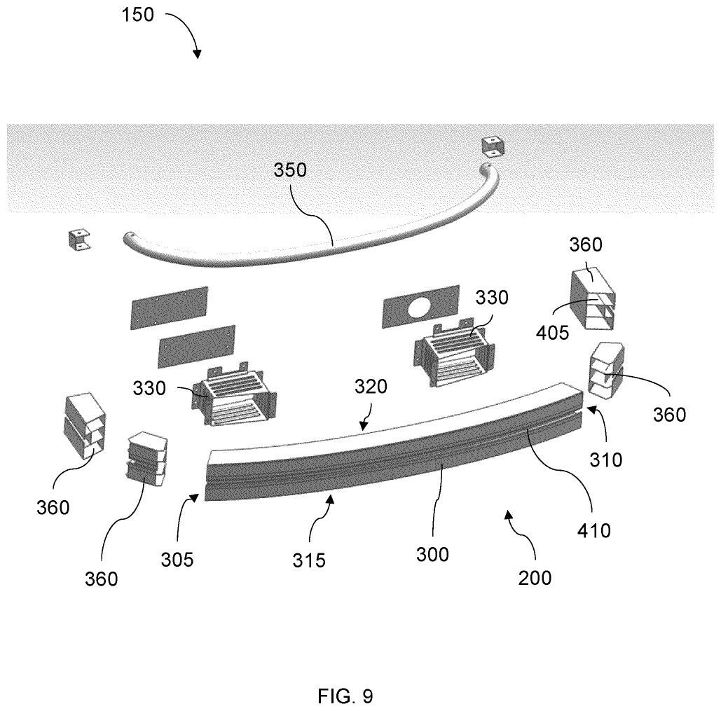

As shown in greater detail in FIGS. 3 and 4, the bumper assembly 200 can include two or more hollow channels 405, shown in support beam 360, that extend from the first end 305 to the second end 310. In one embodiment, the bumper assembly 200 can include three hollow channels 405, as shown in FIG. 4. In another embodiment, the bumper assembly 200 can include two hollow channels 405, as shown in FIG. 9. In yet other embodiments, the bumper assembly 200 can include more or less hollow channels 405. As shown in FIGS. 3, 4, and 9, the hollow channels 405 can extend from the elongated center beam 300 throughout the support beams 360. The bumper assembly 200 can include one or more recessed channels 410 to separate the hollow channels 405. In one embodiment, the recessed channel 410 can be positioned on the front side 315 of the bumper assembly 200, as shown in at least FIGS. 3 and 4. In another embodiment, the recessed channel 410 can be positioned on the rear side 320 of the bumper assembly 200. The recessed channel 410 can include at least one hollow portion, as shown in the support beam 360 in FIG. 3. The recessed channel 410 can be positioned between the hollow channels 405 to separate the hollow channels 405 from one another, as shown in FIGS. 4 and 9.

The bumper assembly 200 can be configured to deform upon impact. For example, the hollow channels 405 can deform (e.g., collapse, buckle, etc.) from the front side 315 of the bumper assembly 200 towards the rear side 320 of the bumper assembly 200 when impacted by an object from the front end 105 of the electric vehicle 100. The bumper assembly 200 can deform (e.g., collapse, buckle, bend, etc.) at the recessed channel 410, as another example. The bumper assembly 200 can be positioned in front of at least one of the plurality of wheels 120 of the electric vehicle 100. For example, the front wheels 120 of the electric vehicle 100 can be positioned on the rear side 320 of the bumper assembly 200 such that the bumper assembly 200 is configured to deform during a front-side impact prior to deformation of the front wheels 120.

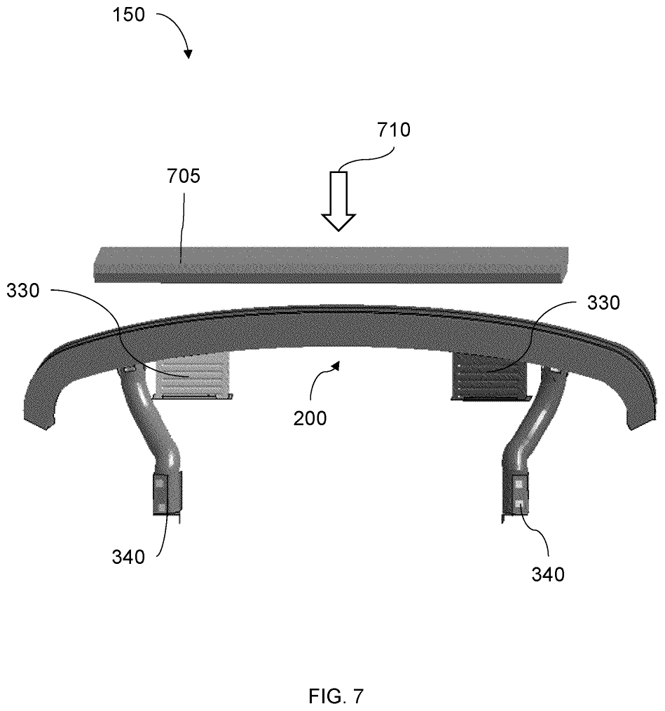

The energy-absorbing impact assembly 150 can include one or more tubular supports 340. In one embodiment, the energy-absorbing impact assembly 150 can include two tubular supports 340, as shown in FIG. 3. In another embodiment, the energy-absorbing impact assembly 150 can include more than two tubular supports 340. According to yet another embodiment, the energy-absorbing impact assembly 150 can include no tubular supports 340, as shown in FIG. 9. As shown in FIGS. 3, 4, 7, and among others, the tubular support 340 can be positioned on the rear side 320 of the elongated center beam 300. The tubular support 340 can be coupled (e.g., fastened, molded, welded, etc.) with one or more components of the electric vehicle 100 in various ways. In one embodiment, the tubular support 340 can be coupled with the bumper assembly 200 such that the tubular support 340 can abut against the rear side 320 of the elongated center beam 300. In another embodiment, the tubular support 340 can be coupled with various other components of the energy-absorbing impact assembly 150 including, but not limited to, a crash box 330. In one embodiment, the tubular support 340 can be made of a metallic material. For example, the tubular support 340 can be made of aluminum, steel, brass, bronze, chromium, copper, nickel, or any combination thereof. In another embodiment, the tubular support 340 can be made of a non-metallic material, such as plastic or an elastomeric material. In yet another embodiment, the tubular support 340 can be made of a combination of a metallic and non-metallic material.

According to various exemplary embodiments, the tubular support 340 can be made of one or more components. For example, the tubular support 340 can include several tubular-shaped components that couple with one another to form the tubular support 340. The tubular support 340 can include one or more components (e.g., cap, plate, bracket, etc.) that facilitate coupling the tubular support 340 with another component of the electric vehicle 100, such as the energy-absorbing impact assembly 150. While the tubular support 340 shown in the exemplary embodiment of the figures defines a substantially cylindrical shape, the tubular support 340 can include a component of various other shapes (e.g., rectangular, hexagonal, etc.) according to other exemplary embodiments. While the tubular support 340 shown in the exemplary embodiment in the figures is substantially hollow, the tubular support 340 can include one or more solid portions (e.g., continuous, without breaks, etc.) according to other exemplary embodiments.

The tubular support 340 can be configured to deform upon impact. For example, the tubular support 340 can deform (e.g. collapse, buckle, etc.) laterally from the front end 105 of the electric vehicle 100 towards the rear end 110. According to one embodiment, the tubular support 340 can be positioned on the rear side 320 of the bumper assembly 200 such that the tubular support 340 can be configured to deform after the bumper assembly 200 begins to deform during impact. According to another embodiment, the tubular support 340 can be positioned on the rear side 320 of the bumper assembly 200 such that the tubular support 340 can be configured to deform at the same time the bumper assembly 200 begins to deform upon impact.

The energy-absorbing impact assembly 150 can include one or more crash boxes 330. In one embodiment, the energy-absorbing impact assembly 150 can include one crash box 330. In another embodiment, the energy-absorbing impact assembly 150 can include two crash boxes 330, as shown in FIG. 3. In other embodiments, the energy-absorbing impact assembly 150 can include more than two crash boxes 330. The crash box 330 can be positioned on the rear side 320 of the elongated center beam 300. The crash box 330 can be coupled (e.g., fastened, welded, molded, etc.) with one or more components of the electric vehicle 100 in various ways. In one embodiment, the crash box 330 can be coupled with the bumper assembly 200 such that the crash box 330 can abut against the rear side 320 of the elongated center beam 300. In other embodiments, the crash box 330 can be coupled with various other components of the energy-absorbing impact assembly 150 including, but not limited to, the tubular support 340.

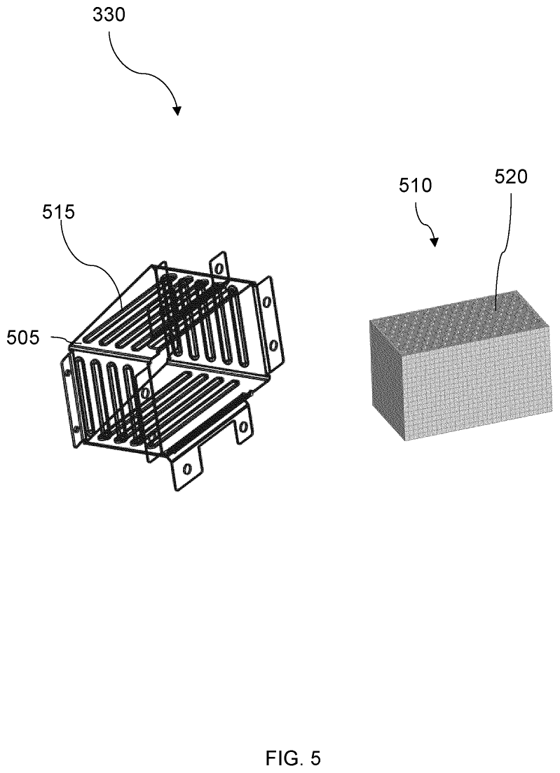

The crash box 330 can include an exterior housing 505 that encloses a cavity, as shown in FIG. 5. The crash box 330 can include an additional absorbing component 510 (e.g., a honeycomb made of walls that define multiple hollow channels) positioned within the cavity. In one embodiment, the additional absorbing component 510 is separate from the exterior housing 505 and can be coupled (e.g., fastened, welded, molded, etc.) with the exterior housing 505, as shown in FIG. 5. In other embodiments, the additional absorbing component 510 can be directly coupled with or connected to the exterior housing 505. In one embodiment, the exterior housing 505 and the additional absorbing component 510 can be made of a metallic material. For example, the exterior housing 505 and the additional absorbing component 510 can be made of aluminum, steel, brass, bronze, chromium, copper, nickel, or any combination thereof. In another embodiment, the exterior housing 505 and the additional absorbing component 510 can be made of a non-metallic material, such as plastic or an elastomeric material. In yet another embodiment, the exterior housing 505 and the additional absorbing component 510 can be made of a combination of a metallic and a non-metallic material. In one embodiment, the exterior housing 505 and the additional absorbing component 510 can include portions made of the same material. In other embodiments, the exterior housing 505 and the additional absorbing component 510 can be made of different material.

While the crash box 330 shown in the exemplary embodiments in the figures includes a generally rectangular shape, the crash box 330 can include components of various other shapes (e.g., cylindrical, hexagonal, etc.) according to various other embodiments. The crash box 330 can be made up of one or more components. For example, the crash box 330 can include a component (e.g., cap, plate, bracket, etc.) to facilitate coupling the crash box 330 with another component of the electric vehicle 100, such as the energy-absorbing impact assembly 150.

The crash box 330 can include one or more guide lines 515. For example, the guide lines 515 can be formed on the exterior housing 505, as shown in FIG. 5. In one embodiment, the guide lines 515 can be a groove, slot, recess, or the like positioned on the exterior housing 505. In another embodiment, the guide lines 515 can be an aperture positioned on the exterior housing 505. In yet other embodiments, the guide lines 515 can be a visual marker. By way of example, the guide lines 515 can be configured to deform (e.g., collapse, buckle, bend, etc.) to facilitate deformation of the exterior housing 505 of the crash box 330 upon impact. The additional absorbing component 510 can include one or more features to facilitate deformation of the crash box 330 during impact. For example, the additional absorbing component 510 can include a plurality of apertures. In one embodiment, the additional absorbing component 510 can include a plurality of apertures to define a plurality of channels 520, as shown in FIG. 5. In another embodiment, the additional absorbing component 510 can include a plurality of perforations or patterns. By way of example, the plurality of channels 520 of the additional absorbing component 510 can deform (e.g., collapse, buckle, etc.) upon impact to facilitate absorption of energy of impact.

The energy-absorbing impact assembly 150 can include one or more support bars 350. For example, the support bar 350 can be positioned on the rear side 320 of the bumper assembly 200. In one embodiment, the support bar 350 can extend in a direction parallel with the elongated center beam 300 of the bumper assembly 200, as shown in FIGS. 3 and 4. In another embodiment, the support bar 350 can extend in a different direction. The support bar 350 can be coupled (e.g., fastened, molded, welded, etc.) with one or more components of the electric vehicle 100 in various ways. In some embodiments, the support bar 350 can be coupled with one or more components of the electric vehicle 100. In other embodiments, the support bar 350 can be coupled with one or more components of the energy-absorbing impact assembly 150. In still other embodiments, the support bar 350 can be coupled with one or more components of the electric vehicle 100 and one or more components of the energy-absorbing impact assembly 150.

The support bar 350 can be made of various materials. For example, the support bar 350 can be made a metallic material including, but not limited to, aluminum, steel, brass, bronze, chromium, copper, nickel, or any combination thereof. In another embodiment, the support bar 350 can be made of a non-metallic material, such as plastic or an elastomeric material. In yet another embodiment, the support bar 350 can be made of a combination of metallic and non-metallic material.

The support bar 350 can include one or more components. For example, the support bar 350 can include a plurality of components coupled together to form the support bar 350. The support bar 350 can include a component (e.g., cap, plate, bracket, etc.) to facilitate coupling the support bar 350 with another component of the electric vehicle 100, as another example. While the support bar 350 shown in the exemplary embodiments in the figures is generally made of a cylindrical shape, the support bar 350 can include one or more components of various other shapes (e.g., rectangular, hexagonal, etc.) according to various other embodiments.

The support bar 350 can be configured to deform upon impact. For example, the support bar 350 can be configured to deform after the bumper assembly 200 begins to deform upon impact. The support bar 350 can be configured to deform at the same time the bumper assembly 200 begins to deform upon impact, as another example. In one embodiment, the support bar 350 can be configured to deform simultaneously with other components of the energy-absorbing impact assembly 150. In other embodiments, the support bar 350 can be configured to deform independently from other components of the energy-absorbing impact assembly 150.

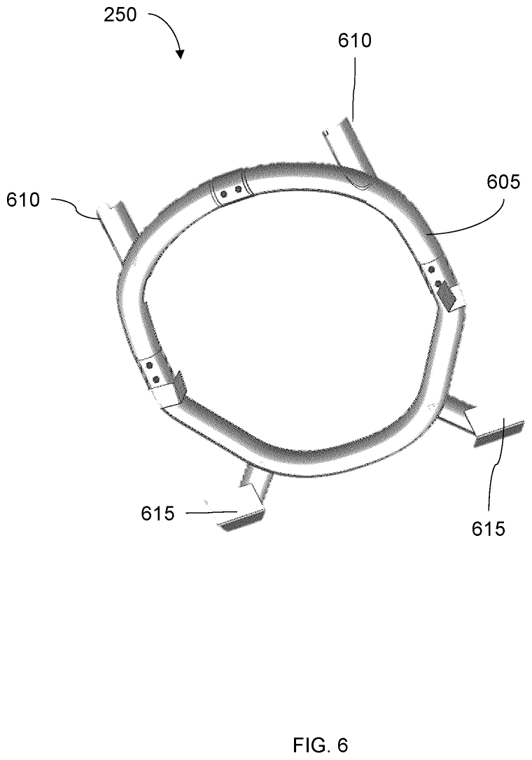

The energy-absorbing impact assembly 150 can include a ring assembly 250. As shown in detail in FIG. 6, the ring assembly 250 can include a ring body 605. The ring assembly 250 can include two or more struts projecting from the ring body 605. In one embodiment, the ring assembly 250 can include one or more front struts 610. In another embodiment, the ring assembly 250 can include one or more rear struts 615. In yet another embodiment, the ring assembly 250 can include front struts 610 and rear struts 615, as depicted in FIG. 6. While the exemplary embodiment in FIG. 6 includes two front struts 610 and two rear struts 615, other embodiments may include more or less front struts 610 and more or less rear struts 615.

The ring body 605 of the ring assembly 250 can be made from various materials. In one embodiment, the ring body 605 can be made of a metallic material. For example, the ring body 605 can be made of aluminum, steel, brass, bronze, chromium, copper, nickel, or any combination thereof. In another embodiment, the ring body 605 can be made of a non-metallic material, such as plastic or an elastomeric material. In yet another embodiment, the ring body 605 can be made of a combination of metallic and non-metallic material.

The struts of the ring assembly 250 can be made from various materials. In one embodiment, the front struts 610 and the rear struts 615 can be made of a metallic material. For example, the front struts 610 and the rear struts 615 can be made of aluminum, steel, brass, bronze, chromium, copper, nickel, or any combination thereof. In another embodiment, the front struts 610 and the rear struts 615 can be made of a non-metallic material, such as plastic or an elastomeric material. In yet another embodiment, the front struts 610 and the rear struts 615 can be made of a combination of metallic and non-metallic material. In some embodiments, the front struts 610 and the rear struts 615 can be made of the same material. In other embodiments, the front struts 610 and the rear struts 615 can be made of a different material.

The ring assembly 250 can be coupled (e.g., fastened, welded, molded, etc.) with one or more components of the electric vehicle 100 in various ways. The front struts 610 of the ring assembly 250 can be configured to couple the ring body 605 with another component of the electric vehicle 100. For example, in some embodiments, the front struts 610 can be integrally formed with the ring body 605 (e.g., molded, welded, etc.). In other embodiments, the front struts 610 can be coupled with the ring body 605 in various other ways (e.g., fastened, joint, etc.). In one embodiment, the front struts 610 of the ring assembly 250 can be configured to be coupled with a component of the energy-absorbing impact assembly 150, such as the crash box 330, the tubular support 340, or the bumper assembly 200. In another embodiment, the front struts 610 of the ring assembly 250 can be configured to be coupled with another component of the electric vehicle 100. In various other embodiments, the ring assembly 250 can be coupled with the electric vehicle 100 directly through the ring body 605.

The rear struts 615 of the ring assembly 250 can be configured to couple the ring body 605 with another component of the electric vehicle 100. For example, in some embodiments, the rear struts 615 can be integrally formed with the ring body 605 (e.g., molded, welded, etc.). In other embodiments, the rear struts 615 can be coupled with the ring body 605 in various other ways (e.g., fastened, joint, etc.). In one embodiment, the rear struts 615 of the ring assembly 250 can be configured to be coupled with a component of the electric battery assembly 230 such as a side portion of the electric battery assembly 230, as shown in FIG. 2. In another embodiment, the rear struts 615 of the ring assembly 250 can be configured to be coupled with another component of the electric vehicle 100. In various other embodiments, the ring assembly 250 can be coupled with the electric battery assembly 230 or the electric vehicle 100 directly through the ring body 605.

While the ring body 605 of the ring assembly 250 shown in the exemplary embodiments in the figures includes a substantially round shape, the ring body 605 can include other various shapes (e.g., rectangular, hexagonal, etc.) according to various other embodiments. The ring assembly 250 can include on or more additional components to facilitate coupling the ring assembly 250 with various components of the electric vehicle 100. For example, the struts can include additional coupling components (e.g., caps, plates, brackets, etc.) to facilitate coupling the ring body 605 with one or more portions of the electric vehicle 100. According to other exemplary embodiments, the ring body 605 can include various components to facilitate coupling the ring assembly 250 with the electric vehicle 100.

The ring assembly 250 can be configured to deform (e.g., collapse, buckle, bend, etc.) upon impact. For example, the ring body 605 of the ring assembly 250 can be configured to deform when a force is applied to the front struts 610, such as during impact. The ring body 605 can deform at a point near the front struts 610 towards the rear struts 615, as an example. In one embodiment, the ring assembly 250 can be positioned on the rear side 320 of the elongated center beam 300 such that the ring assembly 250 can begin to deform after the bumper assembly 200 begins to deform upon impact. In another embodiment, the ring assembly 250 can be configured to begin to deform as the bumper assembly 200 begins to deform upon impact.

The ring assembly 250 can be configured to deform during impact such that the electric battery assembly 230 does not become damaged. For example, the ring assembly 250 can be configured to absorb the energy (e.g., generated force) of impact such that the energy does not impact the electric battery assembly 230. As shown in FIG. 2, the ring body 605 can be coupled (e.g., fastened, welded, molded, etc.) with the electric battery assembly 230 through the rear struts 615 such that a direction of force (e.g., opposing the arrow 125) of impact may not be distributed to an electric battery within the electric battery assembly 230.

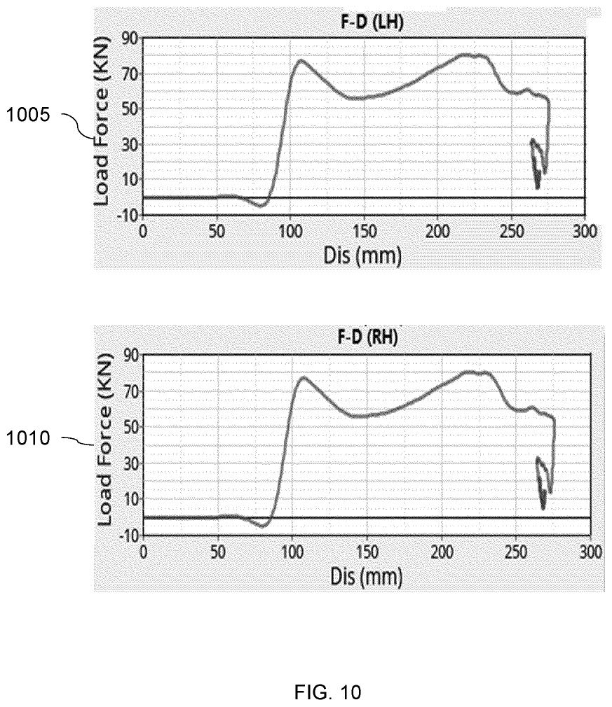

FIG. 10 shows an example of a load force of impact relative to displacement of deformation of the crash box 330 under loading conditions of an object 705 weighing 1200 kilograms impacting the electric vehicle 100 at a velocity of 40 kilometers per hour in a head-on collision, as shown in arrow 710. The graphic 1005 shows a relationship between the load force of impact and the displacement of deformation of a left-hand side crash box 330 (e.g., positioned on a left-hand side of a user within the operating cabin 115 when the electric vehicle 100 is moving in a forward direction of travel as shown in arrow 125). The graphic 1010 shows a relationship between the load force of impact and the displacement of deformation of a right-hand side crash box 330 (e.g., positioned on a right-hand side of a user within the operating cabin 115 when the electric vehicle 100 is moving in a forward direction of travel as shown in arrow 125). As shown in the graphic visuals, the load force of impact has a non-linear relationship with the displacement of the crash box 330. When the displacement of the crash box 330 hits a threshold value, such as about 275 millimeters according to this exemplary embodiment, the load force of impact can substantially decrease as energy becomes absorbed. While the threshold value according to this exemplary embodiment is about 275 millimeters, other embodiments may include more or less displacement to reach a threshold value. For example, a threshold value of the load force can be defined as a measurement of displacement in which the load force begins to decrease. A threshold value of the load force can be defined as a measurement of displacement in which the load force begins to approach zero, as another example. A threshold value of the load force can be defined as a measurement of displacement in which the electric battery assembly 230 would be damaged without the energy-absorbing impact assembly 150, as yet another example.

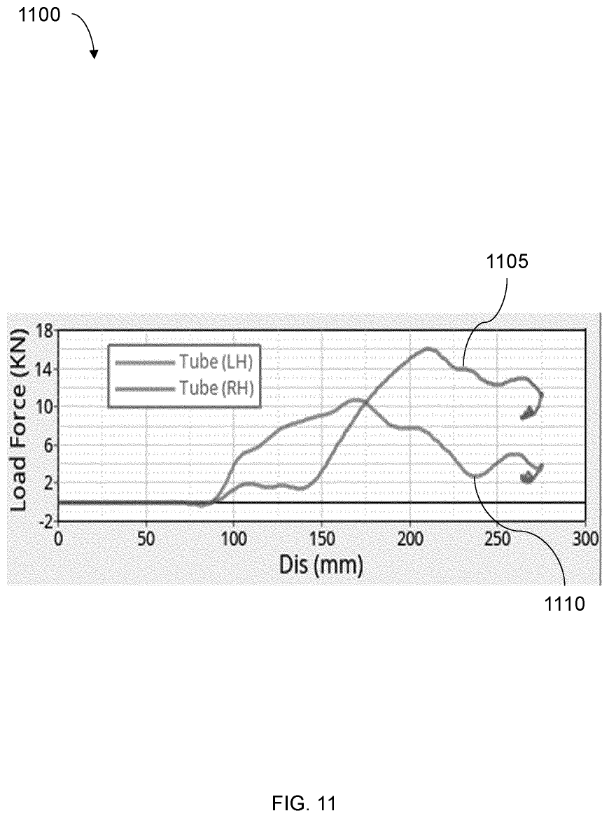

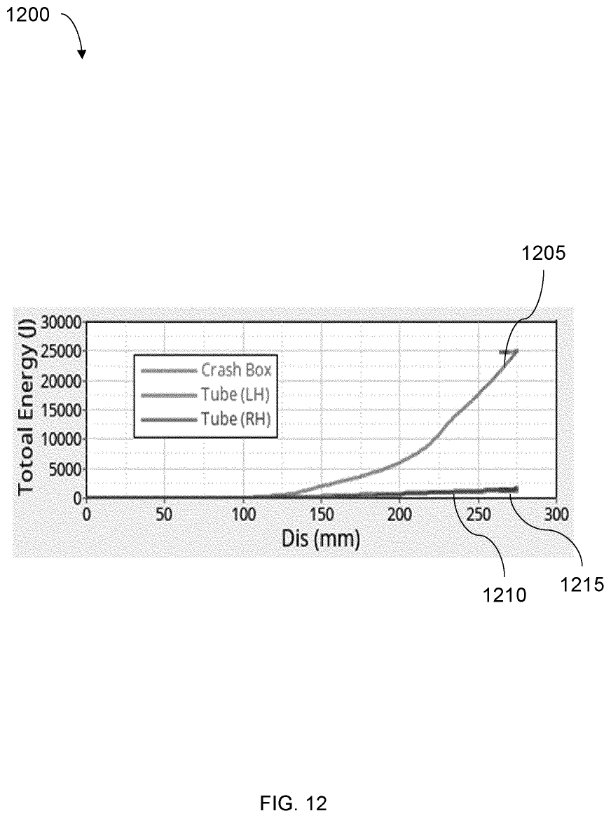

FIG. 11 shows an example of a graphic 1100 depicting a load force of impact relative to a displacement of the tubular support 340 under loading conditions of an object 705 weighing 1200 kilograms impacting the electric vehicle 100 at a velocity of 40 kilometers per hour in the direction of arrow 710. Line 1105 represents a relationship between the load force of impact relative to the displacement of a right-hand side tubular support 340 (e.g., positioned on a right-hand side of a user within the operating cabin 115 when the electric vehicle 100 is moving in a forward direction of travel as shown in arrow 125). Line 1110 represents a relationship between the load force of impact relative to the displacement of a left-hand side tubular support 340 (e.g., positioned on a left-hand side of a user within the operating cabin 115 when the electric vehicle 100 is moving in a forward direction of travel as shown in arrow 125). As shown in FIG. 11, the load force of impact decreases at a certain threshold point of displacement of deformation of the tubular support 340. For example, the threshold point can be a measurement of displacement of deformation of the tubular support 340 in which the load force begins to decrease. The threshold point can be a measurement of displacement of deformation of the tubular support 340 in which the load force begins to approach zero, as another example. The threshold point can be a measurement of displacement of deformation of the tubular support 340 in which the load force of impact would damage the electric battery assembly 230 without the energy-absorbing impact assembly 150, as yet another example. While the threshold point according to the exemplary embodiment shown in FIG. 12 is approximately 210 millimeters for the right-hand side tubular support 340 and approximately 170 millimeters for the left-hand tubular support 340, these measurements can vary under various loading conditions. For example, in other embodiments, a threshold point of displacement of deformation can be more or less than those shown in FIG. 12.

FIG. 12 shows an example of a graphic 1200 depicting a total energy absorbed of impact relative to a displacement of deformation of various components of the energy-absorbing impact assembly 150 under loading conditions of an object 705 weighing 1200 kilograms impacting the electric vehicle 100 at a velocity of about 40 kilometers per hour in the direction of arrow 710. Line 1205 represents a relationship between the total energy absorbed of impact and the displacement of deformation of a crash box 330. Line 1210 represents a relationship between the total energy absorbed of impact and the displacement of deformation of a right-hand side tubular support 340 (e.g., positioned on a right-hand side of a user within the operating cabin 115 when the electric vehicle 100 is moving in a forward direction of travel as shown in arrow 125). Line 1215 represents a relationship between the total energy absorbed of impact and the displacement of deformation of a left-hand side tubular support 340 e.g., positioned on a left-hand side of a user within the operating cabin 115 when the electric vehicle 100 is moving in a forward direction of travel as shown in arrow 125). According to the exemplary embodiment shown in FIG. 12, the total energy absorbed during impact is approximately 53 kilojoules. In other embodiments, the total energy absorbed during impact can be more or less than 53 kilojoules.

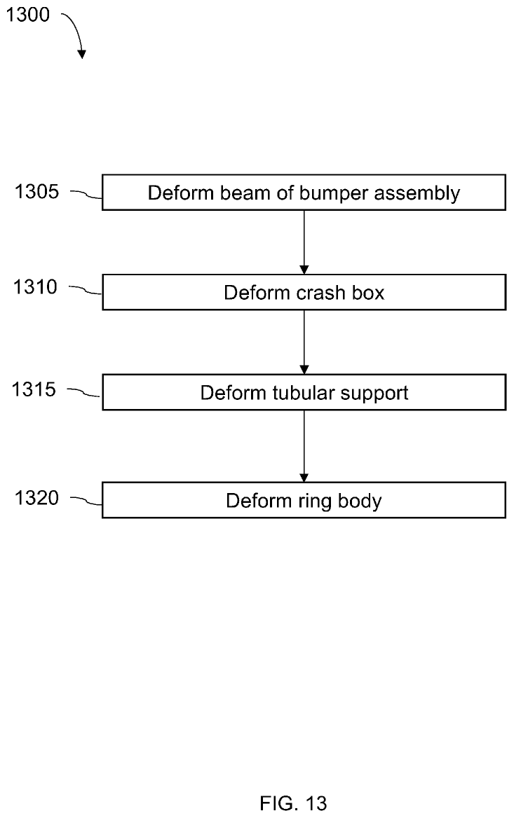

FIG. 13 shows a method 1300 of absorbing energy of impact of an electric vehicle 100. As a brief overview, the method 1300 can include deforming one or more beams of a bumper assembly 200 upon impact, as depicted in act 1305. The method 1300 can include deforming one or more crash boxes 330, as depicted in act 1310. The method 1300 can include deforming one or more tubular supports 340, as depicted in act 1315. The method 1300 can include deforming one or more ring bodies 605, as depicted in act 1320.

The method 1300 can include deforming a beam of the bumper assembly 200 upon impact, as depicted in act 1305. For example, the bumper assembly 200 can include an elongated center beam 300 and one or more additional support beams 360. The elongated center beam 300 and additional support beams 360 can include a plurality of hollow channels 405. The hollow channels 405 can deform (e.g., collapse, buckle, bend, etc.) during impact (e.g., collision, crash, etc.). The bumper assembly 200 can include a front side 315 positioned at a front end 105 of the electric vehicle 100, and a rear side 320 opposing the front side 315. The bumper assembly 200 can deform upon impact such that the front side 315 of the bumper assembly 200 deforms (e.g., collapse, buckle, bend, etc.) towards the rear side 320 of the bumper assembly 200.

The method 1300 can include deforming a crash box 330, as depicted in act 1310. For example, the crash box 330 can include an exterior housing 505 that surrounds an additional absorbing component 510. The absorbing component 510 can include one or more features (e.g., apertures, tunnels, channels, perforations, etc.) to facilitate deformation of the absorbing component 510 during impact. The crash box 330 can include one or more guide lines 515 (e.g., groove, trench, channel, aperture, marking, recess, etc.) positioned on the exterior housing 505. The guide lines 515 can be designed to facilitate deformation of the crash box 330 during impact. The crash box 330 can deform simultaneously with or independently from the bumper assembly 200. For example, the crash box 330 can begin to deform as the bumper assembly 200 begins to deform upon impact. The crash box 330 can begin to deform after the bumper assembly 200 begins to deform upon impact, as another example.

The method 1300 can include deforming a tubular support 340, as depicted in act 1315. For example, the tubular support 340 can be positioned on the rear side 320 of the bumper assembly 200. The electric vehicle 100 can include one or more tubular supports 340. The tubular support 340 can be configured to deform simultaneously with or independently from the bumper assembly 200 and the crash box 330. For example, the tubular support 340 can begin to deform at the same time the bumper assembly 200 begins to deform. The tubular support 340 can begin to deform after the bumper assembly 200 begins to deform, as another example. The tubular support 340 can begin to deform at the same time the crash box 330 begins to deform. The tubular support 340 can begin to deform after or before the crash box 330 begins to deform, as another example.

The method 1300 can include deforming a ring body 605 of a ring assembly 250, as depicted in act 1320. For example, the ring assembly 250 can include one or more struts projecting from the ring body 605. The ring assembly 250 can include two front struts 610 and two rear struts 615, as an example. The ring body 605 can be coupled with one or more portions of the electric vehicle 100 including, but not limited to, the crash box 330, the tubular support 340, the bumper assembly 200, and an electric battery assembly 230. The ring assembly 250 can be configured to deform simultaneously with or independently from the bumper assembly 200, the crash box 330, and the tubular support 340. For example, the ring assembly 250 can begin to deform after the bumper assembly 200 begins to deform upon impact. The ring assembly 250 can begin to deform at the same time the bumper assembly 200 begins to deform upon impact, as another example. The ring assembly 250 can begin to deform at the same time the crash box 330 and the tubular support 340 begins to deform. The ring assembly 250 can begin to deform after or before the crash box 330 and the tubular support 340 begins to deform, as another example.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Language such as the phrases “at least one of X, Y, and Z” and “at least one of X, Y, or Z,” unless specifically stated otherwise, are understood to convey that an element may be either X; Y; Z; X and Y; X and Z; Y and Z; or X, Y, and Z (i.e., any combination of X, Y, and Z). Thus, such language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the electric vehicle 100 and components thereof (e.g., the energy-absorbing impact assembly 150, the wheels 120, etc.) as shown in the various exemplary embodiments is illustrative only. Additionally, any element disclosed in one embodiment may be incorporated or utilized with any other embodiment disclosed herein.

What is claimed is:

1. An energy-absorbing impact assembly for an electric vehicle, comprising:
a bumper assembly including an elongated center beam that extends laterally from a first end to a second end and longitudinally between a front side and a rear side;
a tubular support positioned on the rear side of the elongated center beam for supporting the bumper assembly;
a crash box positioned on the rear side of the elongated center beam for supporting the bumper assembly; and
a ring assembly positioned on the rear side of the elongated center beam, wherein the ring assembly includes a ring body and a plurality of struts that extend from the ring body;
wherein the bumper assembly, the tubular support, the crash box, and the ring assembly are configured to deform with impact.

2. The energy-absorbing impact assembly of claim 1, wherein the elongated center beam of the bumper assembly comprises two hollow channels that extend between the first end and the second end.

3. The energy-absorbing impact assembly of claim 2, wherein the elongated center beam of the bumper assembly includes an additional channel recessed from the front side of the elongated center beam, wherein the additional channel separates the two hollow channels.

4. The energy-absorbing impact assembly of claim 1, wherein the crash box includes an exterior housing that encloses a hollow cavity.

5. The energy-absorbing impact assembly of claim 4, wherein the crash box includes a guide line positioned on the exterior housing.

6. The energy-absorbing impact assembly of claim 4, wherein the crash box includes an additional energy-absorbing component positioned within the cavity.

7. The energy-absorbing impact assembly of claim 1, wherein one of the plurality of struts that extend from the ring body of the ring assembly is coupled with a portion of an electric battery assembly.

8. The energy-absorbing impact assembly of claim 1, wherein one of the plurality of struts that extend from the ring body of the ring assembly is coupled with a portion of one of the crash box, the bumper assembly, or the tubular support.

9. The energy-absorbing impact assembly of claim 1, wherein the bumper assembly includes a first support beam abutting the first end and a second support beam abutting the second end.

10. The energy-absorbing impact assembly of claim 1, comprising a bar positioned on the rear side of the elongated center beam for supporting the bumper assembly.

11. The energy-absorbing impact assembly of claim 1, wherein a portion of the bumper assembly is configured to be a first point of contact with impact.

12. An electric vehicle comprising:
front end and a front wheel;
an electric battery assembly including an electric battery; and
an energy-absorbing impact assembly positioned at the front end, comprising:
a bumper assembly positioned on a front side of the front wheel including an elongated center beam that extends laterally from a first end to a second end and longitudinally between a front side and a rear side;
a crash box positioned on the rear side of the elongated center beam for supporting the bumper assembly; and
a ring assembly positioned on the rear side of the elongated center beam, wherein the ring assembly includes a ring body and a plurality of struts that extend from the ring body;
wherein the bumper assembly, the crash box, and the ring assembly are configured to deform with impact.

13. The electric vehicle of claim 12, wherein the bumper assembly includes an elongated exterior that defines a plurality of hollow channels, wherein one of the plurality of hollow channels includes a recessed portion that extends from the front side of the elongated center beam.

14. The electric vehicle of claim 12, wherein the crash box includes an exterior housing, a chamber enclosed by the exterior housing, and an additional energy-absorbing component positioned within the chamber.

15. The electric vehicle of claim 14, wherein the energy-absorbing component of the crash box includes a plurality of apertures.

16. The electric vehicle of claim 14, wherein the exterior housing of the crash box includes a guide line, wherein the guide line includes a recessed portion positioned on the exterior housing.

17. The electric vehicle of claim 12, comprising a plurality of tubular supports configured to deform upon impact, wherein one of plurality of tubular supports abuts a portion of the bumper assembly.

18. The electric vehicle of claim 12, comprising a support bar positioned on the rear side of the bumper assembly.

19. The electric vehicle of claim 12, wherein the bumper assembly, the ring body of the ring assembly, and the crash box are made of a metallic material.

20. A method of absorbing energy of an impact of an electric vehicle, comprising:
deforming a hollow, elongated beam of a bumper assembly;
deforming a crash box;
deforming an elongated tubular support; and
deforming a ring body of a ring assembly;
wherein the bumper assembly includes a front side, positioned towards a front end of the electric vehicle, and a rear side;
wherein the elongated tubular support is positioned on the rear side of the bumper assembly; and
wherein the ring assembly is positioned on the rear side of the bumper assembly.
